(19) United States
(12) Patent Application Publication
(10) Pub. No.: US 2005/0165919 A1
(43) Pub. Date: Jul. 28, 2005

(54) System and method to simulate and manage a wireless local area network (WLAN)

(76) Inventors: Lu Qian, Solon, OH (US); James Cisar, Wadsworth, OH (US)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/754,951

(22) Filed: Jan. 9, 2004

(51) Int. Cl. G06F 15/173

(52) U.S. Cl. 709/223

(57) ABSTRACT

In accordance with one embodiment, an article of manufacture embodied in a computer-readable medium for use in a processing system for modeling configurations of a wireless local area network is provided. The article of manufacture includes a characteristic and configurations receiving logic for causing the processing system to determine a set of original characteristics and configurations of the wireless local area network. As well, a simulation logic for causing the processing system to simulate an outcome based upon a set of configurations in accordance with a goal. In other embodiments, the goal may be user defined or based upon historical data. Further, a configuration creation logic for causing the processing system to create a set of new configurations based upon the outcome and a management logic for causing the processing system to apply the set of new configurations to the wireless local area network are provided.

### BACKGROUND OF THE ART

Computer and telecommunication networks, specifically wireless networks, have grown in size and complexity. Both of these factors have caused network designers, operators, and users to rely on modeling software to assist them in simulating network configurations to optimize performance. Conventionally, network simulations have been used to evaluate performance of network configurations under defined traffic conditions. Performance includes such objective criteria as response time, throughput, and costs of transmissions.

Recently, the focus of network trends have turned to the wireless local area networks (WLANs). As the popularity of WLANs continues to increase, the deployment density of IEEE 802.11 access points (APs) and the number of client stations has also increased.

This overall increase of IEEE 802.11 radios brings about new challenges for the administrator of an IEEE 802.11 network. Without proper tools, managing the radio environment of an IEEE 802.11 network becomes very difficult. Administrators are plagued with the problem of effectively deploying WLANs and subsequently managing the network in the face of other radio interference, as well as IEEE 802.11 network congestion.

The WLAN administrator is primarily concerned with providing a reliable network with adequate coverage at the highest level of throughput. In order to accomplish this, the administrator today must employ expensive site surveys prior to deployment in combination with costly monitoring tools and personnel expenses used to maintain the network. Even after providing expensive site surveys, the administrator is still plagued with a slow detection of radio network problems and substandard means of making radio network additions or modifications.

Essentially, the optimization of a WLAN is a complex problem. A WLAN is far more dynamic than legacy wired networks. The required timeliness to tune the performance of a WLAN to an optimum is very short.

Although unmanaged and non-optimized WLAN deployments may provide basic functionality, the user experience may greatly erode with the introduction of new wireless traffic. For example, wireless traffic frequently occurs with the wide deployment of WLAN based voice clients (WVOIP).

In this example, in order to achieve acceptable audio quality in WVOIP, problems may occur in that the WLAN may not be able to handle the data traffic required of the network. Conversely, WVOIP clients may be denied access (e.g. get a busy signal) in order to preserve bandwidth for data clients.

Even without WVOIP, some installations could find they have unacceptable data handling capacity. Other problems occur due to factors such as poor positioning of the APs, newly installed neighboring APs, increased user density, new widely used wireless applications, and the like.

Many parameters affect the performance of a WLAN. For example, these parameters include the selection of an AP's frequency band, power levels, protocol settings and shifting client associations between APs. Because of this complexity, conventionally, it has been extremely difficult to analytically determine acceptable algorithms that converge to optimized solutions.

The highly dynamic nature of a WLAN not only makes the network optimization more demanding than ever, but also requires the procedure to reach an optimization very quickly. Optimization speed may be the single most important requirement.

Reaching the optimal performance of a WLAN by adjusting WLAN configurations in real-time is unrealistic because of the significant amount of time it takes to iterate to an optimal performance. Moreover, adjusting WLAN configurations in real-time may adversely affect the WLAN performance during the process of optimization (e.g. spiral into a performance null).

Conventionally, deterministic approaches utilizing management software alone cannot accurately predict the effect of changes on a WLAN. Even people with significant experience in the field of WLANs cannot accurately predict the affect of these changes. Therefore, it is unfeasible for a WLAN management tool alone to provide optimized solutions for a WLAN optimized configuration.

Thus, what is needed is a combined simulation/management means to quickly and accurately determine the effect of given parameter changes before they are applied, or to gather historical usage and performance data and use the gathered data to better optimize system parameters.

In other words, what is needed is a system and method to combine the functionality of a WLAN simulation tool with a management software system to create a model-based system. A system suitably configured to apply Discrete Event Driven MAC protocol simulations to a wireless network management situation in a real time fashion thereby enabling administrators to better optimize the performance of WLANS is needed.

### SUMMARY OF THE DISCLOSED EMBODIMENTS

In accordance with one embodiment, an article of manufacture embodied in a computer-readable medium for use in a processing system for modeling configurations of a wireless local area network is provided.

One embodiment of the article of manufacture includes a characteristic receiving logic for causing the processing system to determine a set of original characteristics of the wireless local area network. As well, a simulation logic for causing the processing system to simulate an outcome based upon the set of original characteristics in accordance with a goal. In other embodiments, the goal may be user defined or based upon historical data.

Further, a configuration creation logic for causing the processing system to create a set of new configuration based upon the outcome and a management logic for causing the processing system to apply the set of new configuration to the wireless local area network are included within the article.

In another embodiment, the simulation logic of the article is a discrete event simulation logic. Alternately, an analysis logic for causing the processing system to determine if the outcome satisfies the goal is provided.

In yet another embodiment, the simulation logic includes a simulation execution logic for causing the processing system to simulate a WLAN based on received network characteristics and a set of configurations with Discrete Event Simulations. Likewise, a prediction logic causes the processing system to predict effects (e.g. total throughput, noise mitigation, access point loading and voice/data distribution) on the wireless local area network based upon the simulation results.

Optimization logic for causing the processing system to optimize the set of new configurations based upon the goal and simulation results is further provided with respect to an alternate embodiment. The algorithm can be any searching algorithm known in the art including, but not limited to, Newton's method or Gradient Search.

Yet another embodiment provides for a display logic for causing the processing system to display a graphical representation of the outcome.

### BRIEF DESCRIPTION OF THE DRAWINGS

It will be appreciated that the illustrated boundaries of elements (e.g. boxes, groups of boxes, or other shapes) in the figures represent one example of the boundaries. One of ordinary skill in the art will appreciate that one element may be designed as multiple elements or that multiple elements may be designed as one element. An element shown as an internal component of another element may be implemented as an external component and vice versa.

FIG. 1 is a system block diagram of a system in accordance with a disclosed embodiment.

FIG. 2 illustrates one embodiment of a methodology for adjusting and/or reconfiguring a WLAN in accordance with a disclosed embodiment.

### DETAILED DESCRIPTION OF ILLUSTRATED EMBODIMENT(S)

The following includes definitions of selected terms used throughout the disclosure. The definitions include examples of various embodiments and/or forms of components that fall within the scope of a term and that may be used for implementation. Of course, the examples are not intended to be limiting and other embodiments may be implemented. Both singular and plural forms of all terms fall within each meaning:

“Computer-readable medium”, as used herein, refers to any medium that participates in directly or indirectly providing signals, instructions and/or data to one or more processors for execution. Such a medium may take many forms, including but not limited to, non-volatile media, volatile media, and transmission media. Non-volatile media may include, for example, optical or magnetic disks. Volatile media may include dynamic memory. Transmission media may include coaxial cables, copper wire, and fiber optic cables. Transmission media can also take the form of acoustic or light waves, such as those generated during radio-wave and infra-red data communications, or take the form of one or more groups of signals. Common forms of computer-readable media include, for example, a floppy disk, a flexible disk, hard disk, magnetic tape, or any other magnetic medium, a CD-ROM, any other optical medium, punch cards, papertape, any other physical medium with patterns of holes, a RAM, a PROM, an EPROM, a FLASH-EPROM, any other memory chip or cartridge, a carrier wave/pulse, or any other medium from which a computer, a processor or other electronic device can read. Signals used to propagate instructions or other software over a network, such as the Internet, are also considered a “computer-readable medium.”

“Logic”, as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic such as an application specific integrated circuit (ASIC), a programmable/programmed logic device, memory device containing instructions, or the like. Logic may also be fully embodied as software.

“Signal”, as used herein, includes but is not limited to one or more electrical signals, analog or digital signals, one or more computer or processor instructions, messages, a bit or bit stream, or other means that can be received, transmitted, and/or detected.

“Software”, as used herein, includes but is not limited to one or more computer readable and/or executable instructions that cause a computer or other electronic device to perform functions, actions, and/or behave in a desired manner. The instructions may be embodied in various forms such as objects, routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software may be dependent on, for example, requirements of a desired application, the environment it runs on, and/or the desires of a designer/programmer or the like.

“User”, as used herein, includes but is not limited to one or more persons, software, computers or other devices, or combinations of these.

In one embodiment, a combination simulation/management modeling system and method to adjust the performance of a wireless local area network (WLAN) is provided. Specifically, in one embodiment, a combined simulation/management system and method is provided that may be configured to apply Discrete Event Driven MAC protocol simulations to a wireless network management in a real-time fashion.

It will be appreciated by one skilled in the art that optimizing a WLAN within a simulated environment, instead of the real-world network environment, may permit the required optimizing speed without adversely affecting the network performance before an optimal solution is obtained.

The present system and method combines a simulator with the management software. Therefore, the present system and method may eliminate the need for a user or administrator to have specific knowledge about WLAN environments and protocols.

As discussed herein, in accordance with the present system and method, once defined goals are input into the system the simulator and management tools artificially develop WLAN parameters and characteristics to accomplish the goals. Once developed, the WLAN parameters and characteristics may be applied by the management tool to the WLAN.

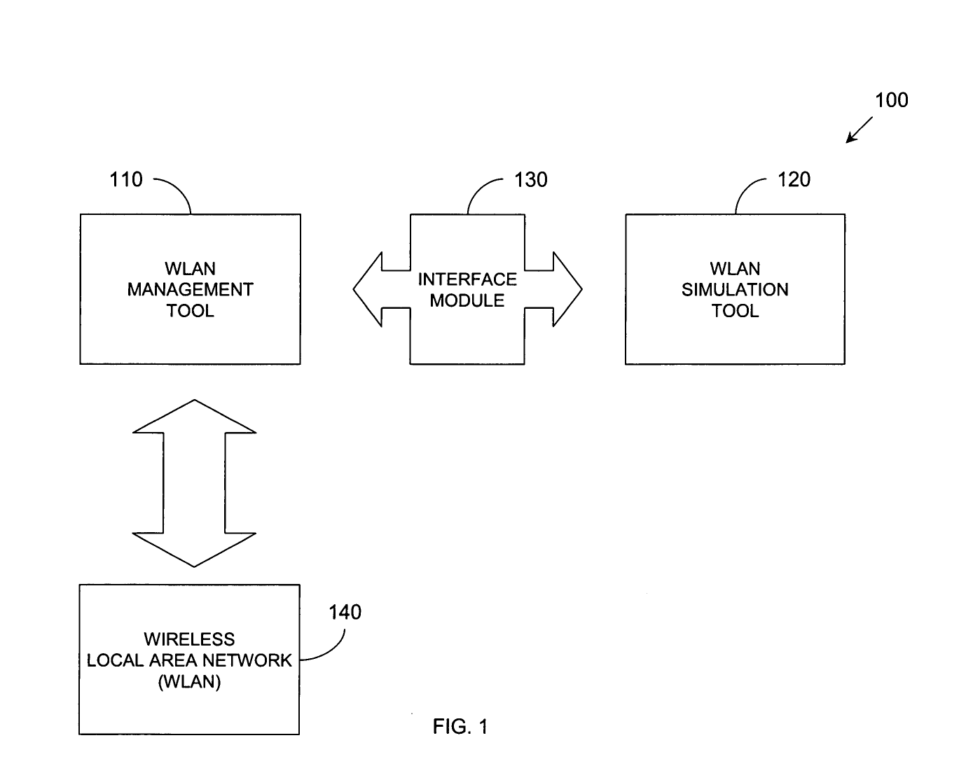

Illustrated in FIG. I is a simplified component diagram of one embodiment of the present system and method. Specifically, FIG. 1 illustrates a block diagram of a system 100 including a WLAN management tool component 110, a simulation tool 120 and an interface module 130 operatively connected to permit the management tool component 110 to communicate with the simulation tool component 130. Finally, illustrated in FIG. 1 is a WLAN 140 operatively connected to WLAN management tool component 110 whereby the WLAN management tool component 110 is suitably configured to adjust the WLAN 140 in accordance with parameters generated by the simulation tool component 120.

In operation, the combination simulation/management system 100 may be suitably configured to quickly and accurately determine the effect of desired parameter changes (e.g. goal(s)) before they are applied. This determination may be accomplished via the WLAN simulation tool 120. Additionally, the system 100 may be configured to gather historical usage and performance data and use the gathered data to better optimize system parameters of the WLAN 140 in accordance with user defined goals.

Of course, it will be appreciated that the goals may be pre-programmed in order to conform to a specified parameter or set of parameters. For example, the system 100 may be programmed to achieve maximum coverage regardless of the data rate in order to maximize throughput.

Continuing with the example, the system 100 may be suitably adapted to apply Discrete Event Driven (DED) MAC protocol simulations via the simulation tool 120 in a real-time fashion to assist administrators to adjust and potentially optimize the performance of the WLAN 140. It will be appreciated by one skilled in the art that any suitably capable management and simulation tool known in the art may be used in connection with the present system.

With reference to the simulation tool 120, the high speed Cisco DES (Discrete Event Simulator) WLAN simulation tool may be employed in accordance with the system described herein. An artisan will appreciate that the DES is written in C++ and is capable of simulating a WLAN 140 in real-time. Further, DES may be configured to accurately simulate the industry standards (e.g. IEEE 802.11 protocols) and may be readily enhanced to conform to new user defined requirements.

Moreover, the DES may be suitably configured to simulate the WLAN 140 environment with regard to a vast number of characteristics (e.g. WLAN configurations). For example, the DES is suitably configured to simulate characteristics and configurations, including, but not limited to, terms of propagating effects, noise, transmit power, receiver sensitivity, adjacent channel interference or the like.

Additionally, it will be appreciated that the DES simulation tool of one embodiment provides a simulation environment directed to an IEEE 802.11 MAC protocol with C++. DES is configured to discern the impact of a PHY layer design or change in a wireless device on the MAC layer performance. For example, DES is capable of determining WLAN coverage range versus data rates. As well, DES, is capable of determining the WLAN capacity in terms of throughput of a multi-channel AP when channel interferences are significant.

Although the simulation environment targets the PHY layer's impact on the MAC layer, it will be appreciated that DES has the potential to be used in other areas such as MAC protocol trade-offs and power save algorithm analysis. For example, in a wireless voice over IP application, simulations built with DES are capable of successfully predicting the WLAN capacities under various configurations, as well as the packet loss and delay characteristics.

Turning now to the management tool 110, in addition to utilizing of any capable WLAN simulation tool such as DES, it will appreciate that any WLAN management tool known in the art may be used in accordance with the present system. For example, the Cisco network management program may be used. It is noted that WLAN management tools and software are configured to simplify the management and control of a WLAN 140 by providing a single point of control for an administrator or user to configure and/or adjust parameters of a WLAN.

Thus, together with the extremely fast simulation speed of the DES simulation tool, a network management program may be empowered as a WLAN management tool in order to make predictable adjustments to WLAN parameters. As well, a network management program may be used in connection with DES to use historical information to do the same and perhaps to employ specific settings tailored to hourly daily traffic and environment conditions.

With a high speed WLAN simulation tool 120 such as the Cisco DES, the WLAN 140 may be optimized quickly through a simulated WLAN environment rather than within the operating network. It will be appreciated that this approach allows for the optimization speed required by the dynamic nature of the WLAN 140 without running the risk of adversely affecting the WLAN 140 performance during the procedure of optimization. Of course, it will be appreciated by one skilled in the art that the present system 100 utilizes a WLAN simulator tool 120 (e.g. Cisco DES) that is fast enough to process the simulation to meet predefined goals.

Referring back to the example, as illustrated in FIG. 1, in order to implement the approach, an interface module 130 is used in connection with the WLAN management tool 110 to interface with the WLAN simulator tool 120. The interface module 130 may be suitably configured to send network configurations and/or performance statistics between the WLAN management tool 110 and the WLAN simulator tool 120. It will be appreciated that the network configurations and performance statistics may be any user defined characteristics (e.g. goal(s)). For example, the characteristics may be AP loading statistics and/or based upon user defined preferences, historical network data or the like.

The simulator tool 120 may be suitably configured to perform WLAN 140 optimization via simulations based upon a predefined configuration or user defined goal. Next, the simulator tool 120 may be configured to send the optimized configurations back to the management tool 110 via interface module 130. Upon receipt, the management tool 110 may be suitably configured to apply the new configurations to the WLAN 140 accordingly.

It will be appreciated that the simulator tool 120 may be a stand-alone component or combined into with the management tool 110 and/or interface module 130. Further, it will be appreciated that the simulation tool 120 may be configured to directly communicate solely with the interface module 130 in order to ultimately transfer the new characteristics to the network management tool 110. Moreover, it will be appreciated that the WLAN simulator tool 120 and the WLAN management tool 110 are not necessarily co-located. In other words, it will be appreciated that the management tool 110 and the simulator tool 120 may be physically located at different locations and suitably configured to communicate with one another via the interface module 130 or other means known in the art (e.g. internet).

In one embodiment, in operation, network characteristics may be transferred via the interface module 130 from the management tool 110 to the simulation tool 120. Next, by using inputted characteristics from the WLAN management tool 110 corresponding with a predefined goal, the WLAN simulator 120 may be suitably configured to execute algorithms in order to select new parameter settings (e.g. characteristics), and to predict the effect on the WLAN 140 with reference to many metrics. For example, the simulator tool 120 may be advantageously configured to predict metrics such as total throughput, AP loading, voice/data distribution and/or the like.

It will be appreciated that the set of optimization parameters (e.g. characteristics) and/or the optimization target functions (e.g. goals) for WLAN 140 performance may be user defined to correspond to any user desired criteria of the WLAN 140. As well, an artisan will appreciate that the simulation tool 120 may be configured to use any applicable optimization algorithm known in the art. For example, the simulation tool 120 may be configured to use optimization algorithms such as Newton's method, Gradient Search, Neural Networks, Exhaustive Search or the like to resolve optimized parameters.

Of course, it will be appreciated that in accordance with alternate embodiments, configurations, goals and other parameters may be maintained or stored via any computer-readable medium known in the art.

In an alternate embodiment, the system 100 may be suitably configured to permit a user or administrator to develop a policy by selecting any general network configuration goal such as maximizing coverage regardless of data rate, maximizing throughput, or specifying location of a particular AP. Once the policy has been developed by the user or administrator, the simulation tool 120 may be configured to apply the policy goals against the converging algorithm. Next, the results of the new WLAN settings or configurations may be subsequently inspected or applied to the WLAN 140.

Yet another embodiment of the present system utilizes a map of the WLAN 140 coverage area. Specifically, the map, as viewed via an optional graphical user interface (GUI) (not shown), may identify placement of network components (e.g. APs) in accordance with the WLAN 140. In accordance with this embodiment, the GUI (not shown) may be suitably configured to assist a user or administrator with the deployment or rearrangement of the network components (e.g. APs). Accordingly, the optional GUI (not shown) used in connection with the simulation tool 120 may be configured to visually illustrate the effect of any changes in WLAN 140 configuration. An artisan will appreciate that the GUI (not shown) display of predicted results may permit the user to confirm the new configurations or to further refine the simulation request.

It will be appreciated that in order to assist an administrator or user to utilize these new features or characteristics more effectively, the GUI (not shown) may be configured to provide a two-dimensional graphical layout of the radio network. Further, the GUI (not shown) may be configured to allow the user to manage the WLAN 140 through a more physical view in addition to the existing logical view provided by the management tool 110. As well, the optional GUI (not shown) may be configured to display system information, such as radio parameters, alarm summary, performance data, as well as rogue-AP's location through the physical view.

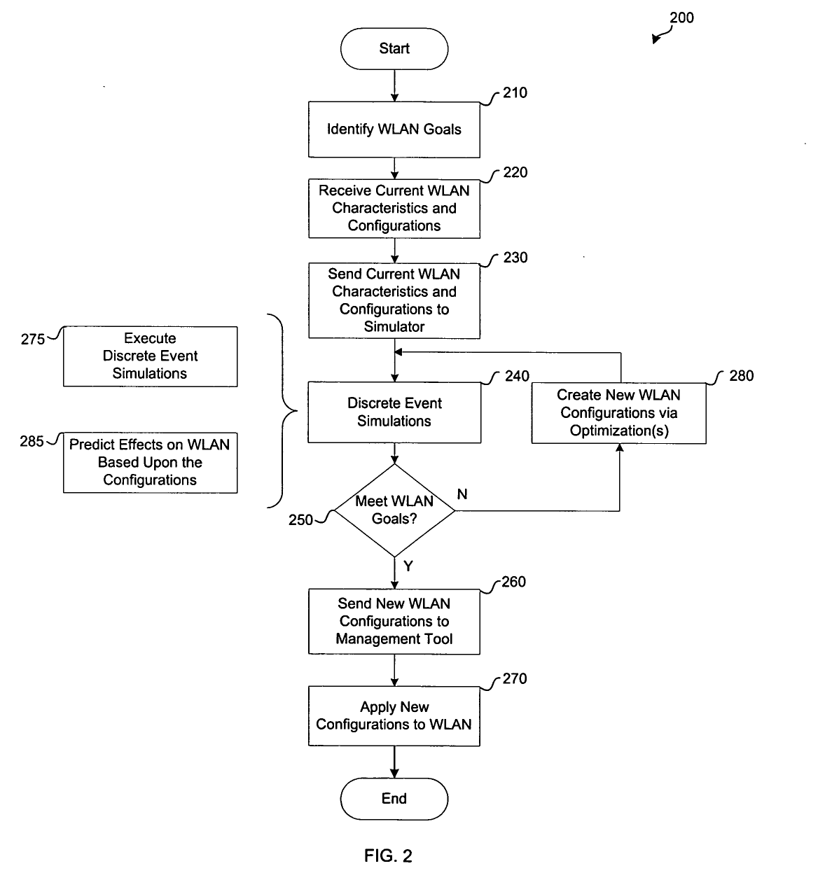

Illustrated in FIG. 2 is one embodiment of a methodology 200 associated with a WLAN simulation/management tool in accordance with the present system.

The illustrated elements denote “processing blocks” and represents instructions or groups of instructions that cause a processor, mechanism, or other device to perform a function, an action, and/or to make a decision. Alternatively, the processing blocks may represent functions and/or actions performed by functionally equivalent circuits such as a digital signal processor circuit, an application specific integrated circuit (ASIC), or other logic device.

The diagram does not depict syntax of any particular programming language. Rather, the diagram illustrates functional information one skilled in the art could use to fabricate circuits, generate computer software, or use a combination of hardware and software to perform the illustrated processing. It will be appreciated that electronic and software applications may involve dynamic and flexible processes such that the illustrated blocks can be performed in other sequences different than the one shown and/or blocks may be combined or separated into multiple components.

With reference to FIG. 2, the methodology 200 will be described with reference to a method to simulate and manage a WLAN based upon predetermined criteria (e.g. user defined goal(s)).

The process is commenced upon identifying WLAN goals (block 210). It will be appreciated that the WLAN goals may be established via user defined parameters. As well, the WLAN goals may be any identifiable network parameter and may be arbitrary or based upon historical network data. For example, a WLAN goal may be defined to strive to maximize coverage regardless of data rate in order to maximize throughput time.

Next, at block 220, the system is suitably configured to receive current WLAN characteristics and configurations. In other words, in one embodiment, the current WLAN characteristics and network configurations and/or performance statistics may be retrieved from the management tool by the interface module. Once retrieved, the current WLAN characteristics and configurations may be transferred from the management tool to the simulation tool via the interface module (block 230).

Upon receipt of the current WLAN characteristics and configurations, the system may be configured to create new WLAN configurations based upon preferred WLAN simulation techniques (block 240). It will be appreciated that any WLAN simulation technique known in the art may be used without departing from the spirit and scope of the present system and/or methodology.

At decision block 250, a query is made to determine if the WLAN goals have been met by the simulation of block 240. If the desired goals have not been met, the system reinitiates the simulation thereby creating new WLAN configurations (block 240) as illustrated in FIG. 2.

If at decision block 250 the system determines that the WLAN goals have been met via simulation of block 240, the system sends the acceptable new WLAN configurations to the management tool (block 260). Finally, at block 270, the new configurations are applied to the WLAN thereby prompting reconfiguration and/or adjustment of the WLAN in accordance with the new configurations. If at decision block 250 the system determines that the WLAN goals have not been met, a new set of configurations will be generated via performing optimizations (block 280). This new set of configurations will then be sent to block 240 for the next iteration of simulations.

As illustrated in FIG. 2, it will be appreciated that the simulation of block 240 may include the steps of: executing simulations (block 275), and predicting the effect of the new configurations on the WLAN (block 285). Of course, an artisan will appreciate the steps included within the simulation block 240.

While the present invention has been illustrated by the description of embodiments thereof, and while the embodiments have been described in considerable detail, it is not the intention of the applicants to restrict or in any way limit the scope of the appended claims to such detail. Additional advantages and modifications will readily appear to those skilled in the art. Therefore, the invention, in its broader aspects, is not limited to the specific details, the representative apparatus, and illustrative examples shown and described. Accordingly, departures may be made from such details without departing from the spirit or scope of the applicant's general inventive concept.

1. An article of manufacture embodied in a computer-readable medium for use in a processing system for modeling configurations of a wireless local area network, the article comprising:
a configuration receiving logic for causing the processing system to determine a set of original configurations of the wireless local area network;
a simulation logic for causing the processing system to simulate an outcome based upon the set of original configurations in accordance with a goal;
a configuration creation logic for causing the processing system to create a set of new configurations based upon the outcome; and
a management logic for causing the processing system to apply the set of new configurations to the wireless local area network.

2. The article set forth in claim 1 wherein the simulation logic is a discrete event simulation logic.

3. The article set forth in claim 1 further comprising an analysis logic for causing the processing system to determine if the outcome satisfies the goal.

4. The article set forth in claim 1 wherein the goal is a user defined goal.

5. The article set forth in claim 1 wherein the goal is a historical-based goal.

6. The article set forth in claim 1 wherein the simulation logic includes a simulation execution logic for causing the processing system to simulate a wireless local area network based upon the set of new configurations.

7. The article set forth in claim 6 wherein the algorithm is Newton's method.

8. The article set forth in claim 6 wherein the algorithm is Gradient Search.

9. The article set forth in claim 1 wherein the simulation logic includes optimization logic for causing the processing system to optimize the set of new configurations based upon the goal.

10. The article set forth in claim 1 wherein the simulation logic includes prediction logic for causing the processing system to predict an effect on the wireless local area network based upon the set of new configurations.

11. The article set forth in claim 10 wherein the effect is one of total throughput, noise mitigation, access point loading and voice/data distribution.

12. The article set forth in claim 1 further including a display logic for causing the processing system to display a graphical representation of the outcome.

13. A system for simulating and managing a wireless local area network, the system comprising:
a simulator logic adapted to process a goal to generate a set of network configurations;
a management logic adapted to process the set of network configurations; and
an interface module adapted to transfer the set of network configurations to the management logic.

14. The system set forth in claim 13 wherein the simulator logic further includes a discrete event simulator logic adapted to process the goal to generate the set of network configurations.

15. The system set forth in claim 13 further comprising a configuration logic adapted to establish the set of network configurations from the goal.

16. The system set forth in claim 13 further including a computer-readable medium adapted to maintain the set of network configurations.

17. A method for adjusting a configuration of a wireless local area network, the method comprising the steps of:
establishing a goal to represent a desired criteria;
generating a set of goal configurations;
simulating a wireless local area network via a discrete event simulation based upon the set of goal configurations;
establishing a set of outcome configurations bases upon the simulation; and
applying the set of outcome configurations to the wireless local area network.

18. The method set forth in claim 17 wherein the goal is a user defined goal.

19. The method set forth in claim 17 wherein the goal is based upon a historical-based goal.

20. The method set forth in claim 17 further comprising the step of executing a simulation algorithm.

21. The method set forth in claim 17 further comprising the step of optimizing an effect based upon the set of goal configurations.

22. The method set forth in claim 17 further comprising the step of displaying an effect on the wireless local area network based upon the set of goal configurations.
